(19) United States
(12) Patent Application Publication
(10) Pub. No.: US 2017/0365928 A1
(43) Pub. Date: Dec. 21, 2017

(54) BROADBAND NOTCH RADIATOR

(71) Applicant: WavCatcher, Inc., Irvine, CA (US)

(72) Inventors: Sheng Yeng Peng, Lynnwood, WA (US); Ronald Westberg, Temecula, CA (US); Peter Y. Peng, Lewisville, TX (US)

(73) Assignee: WavCatcher, Inc., Irvine, CA (US)

(21) Appl. No.: 15/475,861

(22) Filed: Mar. 31, 2017

Related U.S. Application Data
(60) Provisional application No. 62/316,270, filed on Mar. 31, 2016.

(51) Int. Cl. H01Q 9/04; H01Q 13/02; H01Q 1/24

(52) U.S. Cl. CPC H01Q 9/0485; H01Q 1/242; H01Q 13/02

(57) ABSTRACT

This disclosure is directed to a broadband notch radiator antenna. In one aspect, a broadband notch radiator antenna includes a dielectric substrate having a first surface and a second surface. A conductive material is disposed on the first surface to form a horn-shaped dielectric notch antenna. The conductive material disposed on the first surface includes a meander line antenna connected to an edge of the horn-shaped notch. One or more microstrip feed lines and one or more inductance matching circuits are disposed on the second surface. The one or more inductance matching circuits are connected to the one or more feed lines.

### CROSS-REFERENCE TO RELATED APPLICATION

This application claims the benefit of Provisional Application No. 62/316,270, filed Mar. 31, 2016

### BACKGROUND

The proliferation of a wide variety of wireless-communication devices has brought about a wave of new antenna technologies. Mobile phones and wireless networks are just a few examples of wireless, multiple frequency, and multi-mode devices that have driven the advancement of antenna technology. With the advent of Internet of Things (“IoT”) and next generation wireless infrastructures, innovative antenna technology used in current and future wireless-communication devices are expect to have high gain, small physical size, broad bandwidth, versatility and low manufacturing cost, as well as being capable of embedded installation. These antennas are also desired to satisfy performance requirements over particular and multiple operating frequency ranges. For example, fixed-device antennas, such as cellular base-stations and wireless access points, demand high gain and stable radiation coverage over a selected operating frequency range. On the other hand, antennas for portable wireless devices, such as mobile phones, smartphones, tablets, laptop computers and wearable electronics, are preferred to be efficient in radiation and spatial coverage. These antennas utilize proper impedance matching over selected operating frequency ranges.

### SUMMARY

This disclosure is directed to a broadband notch radiator, which is a printed circuit horn antenna configuration that integrates meander line, loop or similar line antenna footprint into an overall antenna element. A few examples of this configuration include: a single printed circuit horn antenna element with one or more meander line antennas connected at the edge(s) of the element aperture; or one or more printed circuit horn antenna element(s) with one or more meander line antennas integrated within the aperture of the element(s).

Features of the Broadband Notch Radiator include: broadband frequency coverage which can cover over 600% frequency bandwidth in single or multiple ports (thus eliminating the use of multiple antennas or a power divider); optimal radiation pattern and peak gains; targeted frequencies of interest; and orthogonal polarizations. The meander line, loop or a similar line antenna configuration outside of the matching circuit(s) increases the native horn's bandwidth capacity and can raise or lower the operational frequencies. The overall intent is to achieve lower frequencies of interest without increasing the size of the horn element, but the antenna gain will be reduced somewhat at the fringes of the targeted frequency bandwidth. Overall, the Broadband Notch Radiator provides the widest frequency bandwidth coverage with optimal radiation pattern and antenna gain in the smallest possible and customizable printed circuit footprint as well as offer variable (one or more) feed ports without any reductions in performance, which occurs in antenna solutions that may require a power divider or splitter.

The construct of the broadband notch radiator, in one aspect, is a customized printed circuit horn antenna element with a notch or slot with a first surface and a second surface located opposite the first surface, preferably on a radio frequency (“RF”)—friendly dielectric substrate, flexible or rigid. A conductive layer is disposed on the first surface and has a notch region that may expose a dielectric substrate (if utilized) between the edges of the conductive layer. The broadband notch radiator also includes one, two or more frequency matching circuits that branch from the notch region. Each matching circuit is configured to send and receive electromagnetic radiation in a broadband or ultra-broadband frequency band of the radio spectrum.

The estimated peak gain(s) of a broadband notch radiator antenna element is around +4 dBil towards the frequencies of interest covered by the aperture of the horn and tapers lower to around +2 dBil at the frequencies of interest covered at the region of the grafted meander line antenna(s). The tapered gain may be lower than +2 dBil if an alternative printed circuit line antenna(s) is utilized instead of the preferred and optimized meander line antenna solution.

Broadband notch radiator expands a portable wireless device's RF coverages, a specific inductive coupling technique that matches an external housing construct (e.g. case) to fit the wireless portable device as a “plug and play” solution. This inductive coupling solution depends on e-field RF “hot” spots which may be unique for each portable device. In particular, there are two main considerations: the spacing between the broadband notch radiator and the wireless portable device; and the feedlines and end of the feed lines, hence referenced as “probes.”

The spacing between the broadband notch radiator and a portable wireless device determines the mutual coupling RF effect. A thin dielectric loading or calculated air spacing prevents shorting of the broadband notch radiator's response to the portable device's ground plane. In an actual use case, a Broadband Notch Radiator is separated from the surface of a portable wireless device by a thin dielectric (similar to PolyCarbonate, FR-4, PVC, etc.) at a thickness of around 0.035″-0.040″. In our development example, the plastic spacing of er=3.1 at 0.040″ element separates the Broadband Notch Radiator from the ground plane of this particular portable wireless device. Additionally, this dielectric thickness locks in the Broadband Notch Radiator separation to the ground plane of the portable wireless device for repeatability and optimized response. Just as a higher dielectric will reduce the physical size of the Broadband Notch Radiator, a higher dielectric will reduce the spacing between the Broadband Notch Radiator and the ground plane of the portable wireless device. For instance, air spacing or an air gap of er=1.0 will also perform but at a further distance than ideal for building the housing to cover the portable wireless device.

A second consideration to inductively couple a Broadband Notch Radiator(s) to a portable wireless device (e.g. smartphone, tablet, portable PC) that may enhance the device's signaling abilities is to design the appropriate feedlines and its probes for the Broadband Notch Radiator to capture and passively re-radiate the energy. This is executed by disassembling the device and locating the embedded RF feed points. After the embedded RF elements are located, an RF pigtail feed can be soldered by removing the device manufacturer's micro/mini surface mount connector. The next step is to conduct a RF sweep for the portable device's embedded RF performance. Each RF element in the portable device will have a unique frequency for each port in which the engineer records the embedded Return Loss response. Following this step, “hot” e-fields from embedded RF elements in a portable wireless device are located using a customized pigtail feed to transmit (or receive) S21 on a network analyzer and receive using a customized microstrip probe. The microstrip probe's small area of ground plane is removed as to pick up these e-fields to locate the best place to pick up RF energy from the embedded RF element. The microstrip field probe over the dielectric PC board can be a “Straight Microstrip Probe” or a “Straight Microstrip Probe With Right Angle” to pick up the best RF field strength. The “hottest” e-field coupling geometry is optimized with a Straight Probe or Straight Microstrip Probe With Right Angle over the dielectric PC board. This “hot e-field” location is locked in, physically measured and drawn in CAD (or similar application/program). This location is then designed around the external Broadband Notch Radiator element(s) which is separated from the portable wireless device with a plastic or similar dielectric or air dielectric that separates the Broadband Notch Radiator(s) from the portable wireless device. To physically test the Broadband Notch Radiator's performance on the portable wireless device, its probe(s) are connected with microstrips and optimized with RF edge mount connectors. In the case of a recent application which utilized two broadband notch radiator elements, this inductive coupling procedure is repeated with the upper “hot” e-fields for a total of four probes for upper and lower hot spots and element for diversity.

At present, there is a documented desire for super antennas or antenna-enhanced solutions for fixed/mobile wireless infrastructure and portable/mobile wireless devices. It is preferred by the manufacturers that these solutions do not require additional power and are low cost and capable of embedded installation as well as are able to receive and transmit over broad bandwidths for multiple frequency or multi-mode wireless communication devices and systems. The broadband notch radiator creation described here satisfies all the desired parameters and more because it is inherently a suit-to-fit solution.

The concept for the broadband notch radiator arose from the necessity for a conformal broadband high gain antenna(s) to reach sub-1,000 MHz frequencies to fit within the size constraints of current mobile and portable wireless devices; and for the same antenna(s) to service multiple radios by engineering multiple ports as well as a successful inductive coupling solution which prevents the use of the antenna(s) to directly connect to the device's transmission/receive (TR) module(s). One particular example is a portable device case or housing that enhances targeted RF signal reception and coverage for the wireless portable device the case or housing is fitted on.

There is no known past utilization of a meander line, loop or similar line antenna(s) integrated at the edge(s) of the aperture of a printed circuit horn antenna element, henceforth broadband notch radiator, which increases the frequency bandwidth at the targeted frequencies of interest. Furthermore, the inductive coupling abilities of the broadband notch radiator make it an effective parasitic antenna element, thusly a true passive radiator, since it may be utilized as a conductive element not electrically connected to anything else.

To elaborate further, the clear advantage of the broadband notch radiator is its ability to allow the antenna designer to utilize the inductive coupling technique to expand the RF coverage of the device the broadband notch radiator is parasitically coupled to. The inductive coupling process for the broadband notch radiator allows this printed circuit element(s) to be integrated into selected and ideally RF-friendly constructs, flexible or rigid, in which the antenna feed port(s) do not require any physical connection to the T/R module(s) or radio(s). The goal in the engineering process is to avoid negative mutual coupling, and the feed line design as well as the design of the end points of the feed line(s), henceforth referenced as probe(s), are important procedural elements to ensure that the selected RF coverage of the coupled wireless device is significantly expanded.

The value proposition of the broadband notch radiator is immense, because it is arguably the holy grail of antenna technologies. Its inherent broadband characteristics and variable port offerings, single or multiple, eliminate the use of multiple antennas which are typically narrow in bandwidth and significantly larger in size. The Broadband Notch Radiator can provide equal or greater benefits in the same or smaller form factors in contrast to current antenna products and solutions. Therefore, the Broadband Notch Radiator clearly reduces cost, potentially enhances technical performance and is essentially a suit-to-fit solution which is ideal for almost any wireless application.

### BRIEF DESCRIPTION OF THE DRAWINGS

FIG. 1A shows an illustration of a working Broadband Notch Radiator antenna element which is configured for a waveguide for an infrastructure antenna.

FIG. 1B shows illustrations of two different working Broadband Notch Radiators designed for a smartphone case to address the radios and standards for GPS, Bluetooth, WiFi at 2.4/5.0/5.8 GHz and Cellular Diversity for frequencies as low as 600 MHz.

FIG. 2C shows an illustration of a working Broadband Notch Radiator that uses inductive coupling to expand a portable wireless device's selected RF coverage, where the first port addresses cellular standards for the frequency ranges of 700-800 MHz and 1.7-2.3 GHz, and the other port addresses Bluetooth and WiFi standards for the frequency ranges of 2.4/5.0/5.8 GHz.

FIG. 2A shows an illustration of a Meander Line Phased Array Antenna Element designed to be grafted to the edge of the aperture(s) of a custom printed circuit horn antenna element (It should be noted that the Meander Line Phased Array Antenna Element shown is not limited to the dimensions indicated in this figure).

FIG. 2B highlights the reactive loading locations of a Meander Line Phased Array Antenna Element designed to be grafted to the edge of the aperture(s) of a circuit horn antenna element (It should be noted that the Meander Line Phased Array Antenna Element shown is not limited to the dimensions indicated in this figure).

FIG. 3A shows a dimensional drawing of a Broadband Notch Radiator incorporated on a separate housing (e.g. case) that fits a portable wireless device (e.g. smartphone) (It should be noted that the Broadband Notch Radiator shown is not limited to the dimensions indicated in this figure).

FIG. 3B shows a picture of a design sample of a Broadband Notch Radiator incorporated on a separate housing (e.g. case) that fits a portable wireless device (e.g. smartphone).

FIG. 3C shows a sample of the measured return loss data of a Broadband Notch Radiator incorporated on a separate housing (e.g. case) that fits a portable wireless device (e.g. smartphone).

FIG. 4A shows a picture of an alternative design sample of a Broadband Notch Radiator using different matching circuits incorporated on a separate housing (e.g. case) that fits a portable wireless device (e.g. smartphone).

FIG. 4B shows the measured return loss for frequencies from 500 MHz to 6 GHz for the first port of an alternative design sample of a Broadband Notch Radiator using different matching circuits incorporated on a separate housing (e.g. case) that fits a portable wireless device (e.g. smartphone).

FIG. 4C shows the measured return loss for frequencies from 500 MHz to 6 GHz for the other port of an alternative design sample of a Broadband Notch Radiator using different matching circuits incorporated on a separate housing (e.g. case) that fits a portable wireless device (e.g. smartphone).

FIG. 5 shows a projected dimensional drawing of a 3-port Broadband Notch Radiator incorporated on a separate housing (e.g. case) that fits a portable wireless device (e.g. smartphone) (It should be noted that the Broadband Notch Radiator shown is not limited to the dimensions indicated in this figure).

FIG. 6 shows an illustration of two working Broadband Notch Radiators integrated into a separate housing that fits a portable wireless device, in this case a smartphone, in which one element addresses diversity cellular radios and the other element addresses both GPS and WiFi/Bluetooth radios (It should be noted that the Broadband Notch Radiator shown is not limited to the dimensions indicated in this figure).

FIG. 7 shows an illustration of the potential housing (e.g. case) to fit a portable wireless device, in this case a smartphone, with a single integrated Broadband Notch Radiator that covers the radios for Cellular, WiFi and Bluetooth.

FIG. 8A shows a photo of an inductive coupling use case in which a disassembled smartphone's internal embedded antenna feeds are located.

FIG. 8B shows photos of an inductive coupling use case in which a pig tail small RF feed probe is used to find where each embedded antenna and frequency band is located with the cable to be connected to a network analyzer.

FIG. 9A shows the Return Loss measured data for the port of an embedded cellular antenna referenced in the inductive coupling use case depicted in FIG. 10.

FIG. 9B shows the Return Loss measured data for the port of a different embedded cellular antenna referenced in the inductive coupling use case depicted in FIG. 10.

FIG. 10A shows a photo of the dielectric separator utilized in the inductive coupling use case referenced in FIGS. 10 and 11. For this development program, a transparent plastic smartphone case shell is the selected platform for inductive coupling of the Broadband Notch Radiator(s).

FIG. 10B shows photos of the process of locating the RE “hot” e-fields on each side of the transparent plastic smartphone case shell referenced in FIG. 12A.

FIG. 11A shows a technical drawing of a Broadband Notch Radiator with a Straight Microstrip Probe and a Straight Microstrip Probe with Right Angle located at the end of the feedlines utilized in the inductive coupling use case referenced in FIGS. 10, 11 and 12 (It should be noted that the Broadband Notch Radiator shown is not limited to the dimensions indicated in this figure).

FIG. 11B shows a technical drawing of a Straight Microstrip Probe and a Straight Microstrip Probe with Right Angle test fixture utilized in the inductive coupling use case referenced in FIGS. 10, 11 and 12 (It should be noted that the Straight Microstrip Probe shown is not limited to the dimensions indicated in this figure).

FIG. 11C shows a photo of a Straight Microstrip Probe and a Straight Microstrip Probe with Right Angle test fixture utilized in the inductive coupling use case referenced in FIGS. 8, 9, 10 and 11B.

FIG. 12 shows the measured data resulting from use of the probe text fixture referenced in FIGS. 11B and 11C regarding the inductive coupling use case referenced in FIGS. 8, 9, 10 and 11.

FIG. 13A shows a photo of a network analyzer connected to the wireless portable device covered by the Broadband Notch Radiator integrated platform referenced in the inductive coupling use case referenced in FIGS. 8-12.

FIG. 13B shows the Rectangular s21 plots depicting the embedded and microstrip “hot” e-field responses of the tested device indicated in FIG. 13A concerning the inductive coupling use case referenced in FIGS. 8-12.

FIG. 13C shows a photo of the tested device locking down the location of the Broadband Notch Radiator on the dielectric separator (transparent case) finalizing the inductive coupling procedures in the use case detailed in FIGS. 8-13.

### DETAILED DESCRIPTION

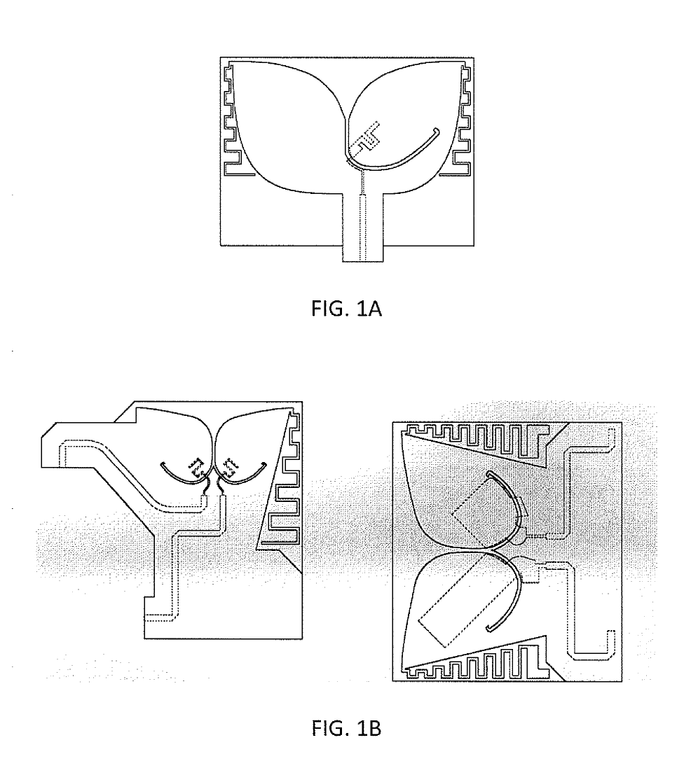

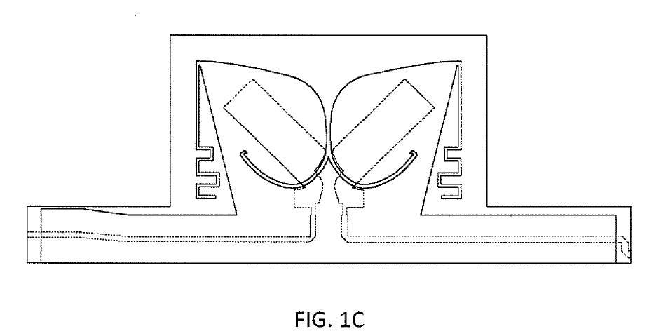

FIG. 1A shows an illustration of a broadband notch radiator antenna element which is configured for a waveguide for an infrastructure antenna. The Broadband Notch Radiator has two meander line antennas located at edges of the circuit horn antenna element. In this case for wireless infrastructure, the broadband notch radiator element may be positioned orthogonally, typically perpendicular, to an identical element to offer optimal dual linear polarization. A phased array infrastructure antenna product utilizing Broadband Notch Radiator elements will typically offer higher gain than current antenna solutions on the market as well as reduces the use of multiple narrow band antennas which in turn reduces the overall form factor, and thus, cost.

FIG. 1B shows an illustration of two different working Broadband Notch Radiators designed for a smartphone case to address the radios and standards for GPS, Bluetooth, WiFi at 2.4/50.0/5.8 GHz and Cellular Diversity for frequencies as low as 600 MHz. The Broadband Notch Radiator has a meander line antenna located at an edge of the circuit horn antenna element. Although a single Broadband Notch Radiator element can be designed with multiple ports to address each RF “hot” e-field, dual Broadband Notch Radiators integrated in the housing of a portable wireless device can allow for housing flexibility which results in easier insertion and removals of a device from the housing by an end user.

FIG. 1C shows an illustration of a working Broadband Notch Radiator that uses inductive coupling to expand a portable wireless device's selected RF coverage, where the first port addresses cellular standards for the frequency ranges of 700-800 MHz and 1.7-2.3 GHz, and the other port addresses Bluetooth and WiFi standards for the frequency ranges of 2.4/5.0/5.8 GHz. This dual port Broadband Notch Radiator demonstrates two meander line antennas grafted without soldering to the dual edges of the circuit horn antenna element. These two meander line antennas provide sub-1 GHz frequencies to the element and eliminates the need to scale larger the circuit horn antenna to meet the lower frequencies of interest. Ultimately, this dual port Broadband Notch Radiator can provide a frequency bandwidth from 300% to 600% and higher with peak gain reaching +2 dBil to +4 dBil. It should be mentioned that the inductive coupling method uses near field coupling between the two ports. The separation distance between the portable wireless device's embedded antenna and the integrated Broadband Notch Radiator element in a separate housing that fits a portable device is such as 0.005″ to 0.010″ or may be any other suitable distance between the port of embedded antenna and the port of the external Broadband Notch Radiator integrated in separate housing for the device (e.g. case or similar construct).

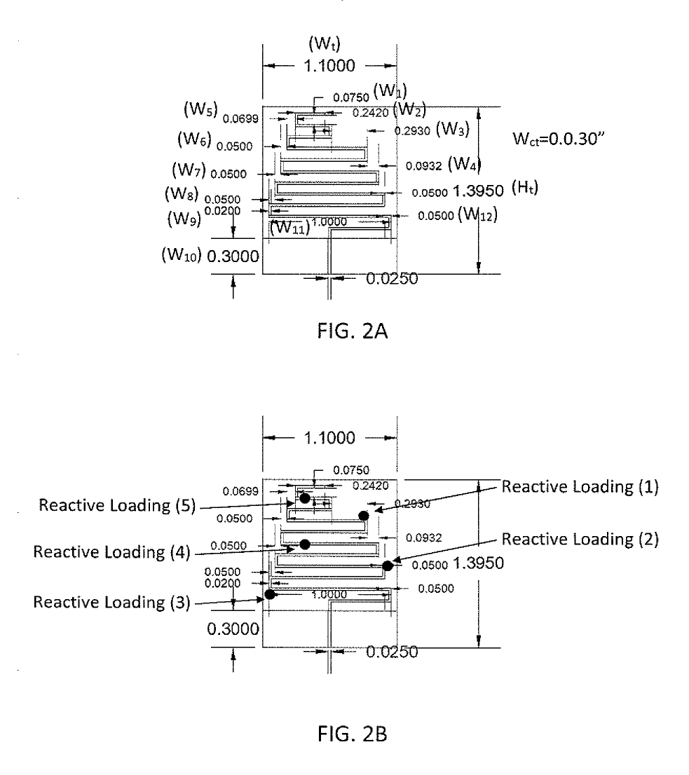

FIG. 2A shows an illustration of a Meander Line Phased Array Antenna Element grafted to the edge of the aperture(s) of a circuit horn antenna element. The design parameters for this meander line antenna element are identified as follows:
(1) W_{f} - - - Feed Line Width, for example, W_{f}=0.025″
(2) Wₜ - - - Circuit Board Width, for example, Wₜ=1.100″
(3) W_{ct} - - - Circuit Board Thickness, for example, W_{ct}=0.030″
(4) Hₜ - - - Circuit Board Height, for example, Hₜ=1.395″
(5) W₁ - - - Space between the first and second Top Horizontal Meander Line Edges, for example, W₁=0.075″
(6) W₂ - - - Top Horizontal Meander Line Length, for example, W₂=0.242″
(7) W₃ - - - Space between the first and second Right Edges from the Top Vertical Meander Line, for example, W₃=0.293″,
(8) W₄ - - - Space between the second and third Right Edges from the Top Vertical Meander Line, for example, W₄=0.0932″
(9) W₅ - - - Space between the first and second Left Edges from the Top Vertical Meander Line, for example, W₅=0.0699″
(10) W₆ - - - Space between the second and third Left Edges from the Top Vertical Meander Line, for example, W₆=0.050″
(11) W₇ - - - Space between the third and fourth Left Edges from the Top Vertical Meander Line, for example, W₇=0.050″
(12) W₈ - - - Space between the fourth and fifth Left Edges from the Top Vertical Meander Line, for example, W₈=0.050″
(13) W₉ - - - Line Width of Meander Line, both Vertical and Horizontal, for example, W₉=0.020″
(14) W₁₀ - - - Feed Line Length, for example, W₁₀=0.300″
(15) W₁₁ - - - Bottom Meander Line Length Layer Length, for example, W₁₁=1.000″
(16) W₁₂ - - - Space between the fourth and fifth Right Edges from the Top Vertical Meander Line, for example, W₁₂=0.050″

FIG. 2B highlights the reactive loading locations of a Meander Line Phased Array Antenna Element designed to be grafted to the edge of the aperture(s) of the circuit horn antenna element. The illustration shows a meander line antenna design sample and its reactive loading locations. In this example, there are 5 reactive loading locations in which the meander line antenna design is based on the radiation condition which is:

WL=1/WC

W=2×3.1416×F F=Frequency of Interest L=Inductance C=Capacitance Under this radiation condition, the radiation frequency F is controlled by the value of Inductance (L) and Capacitance (C). It should be pointed out here that there are 5 different values of L and 5 different values of C. Therefore, there are 5 different resonant frequencies.

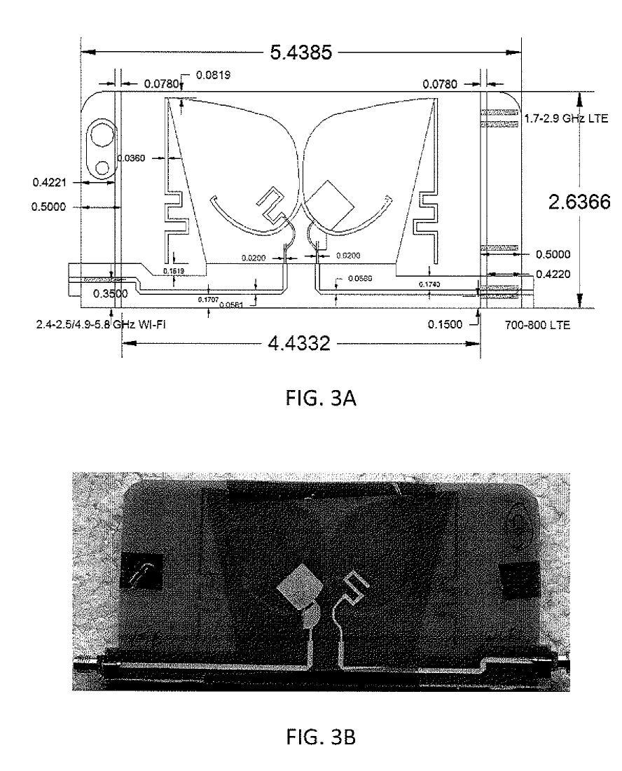

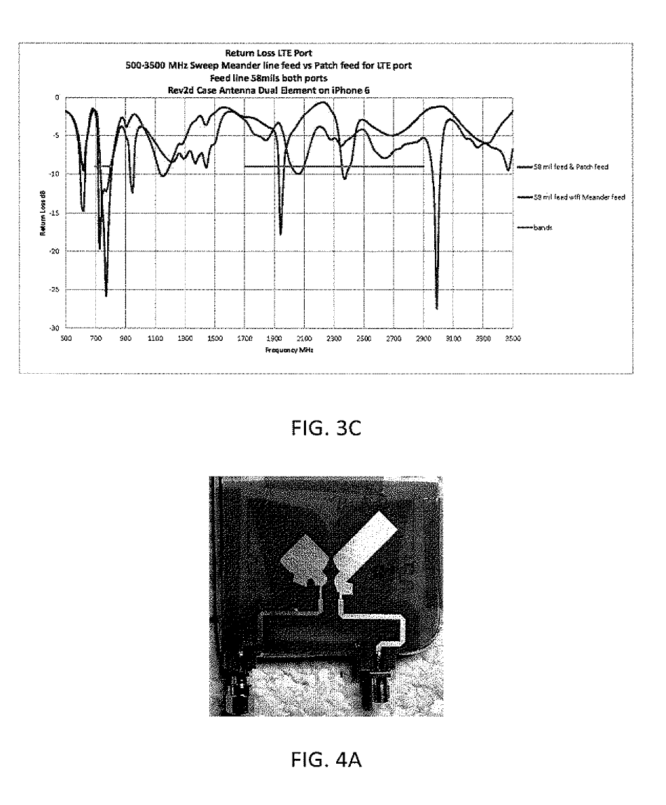

FIG. 3A shows a dimensional drawing of a Broadband Notch Radiator incorporated on a separate housing (e.g. case) that fits a portable device (e.g. smartphone). This example illustrates that there are two ports: one port is using a patch antenna configuration for Inductance (or L) in its matching circuit and the other port is using a meander line antenna configuration for inductance (or L) in its matching circuit. In addition, there are two meander line antennas connected to the two edges of the aperture of the circuit horn antenna element.

FIG. 3B shows a picture of a design sample of a Broadband Notch Radiator incorporated on a separate housing (e.g. case) that fits a portable device (e.g. smartphone). The picture clearly shows two different matching circuits at two ports as described in the previous paragraph. This figure also shows that the antenna has two meander line antennas in which each antenna is grafted to the edges of the aperture of the circuit horn antenna element. In this example, these two meander line antennas provide low frequency coverage at 700-800 MHz, while the circuit horn antenna element covers a broader frequency range at 1,000-6,000 MHz and higher.

FIG. 3C shows a sample of the measured return loss data of a Broadband Notch Radiator incorporated on a separate housing (e.g. case) that fits a portable wireless device (e.g. smartphone). It is noted in this sample that the measured performance is good at the targeted frequencies of interest which are 700-800 MHz and 1,700-2,900 MHz. It should also be noted that the measured performance at one port using the rectangular patch configuration at its matching circuit is similar to that of the other port which uses a meander line configuration at its matching circuit.

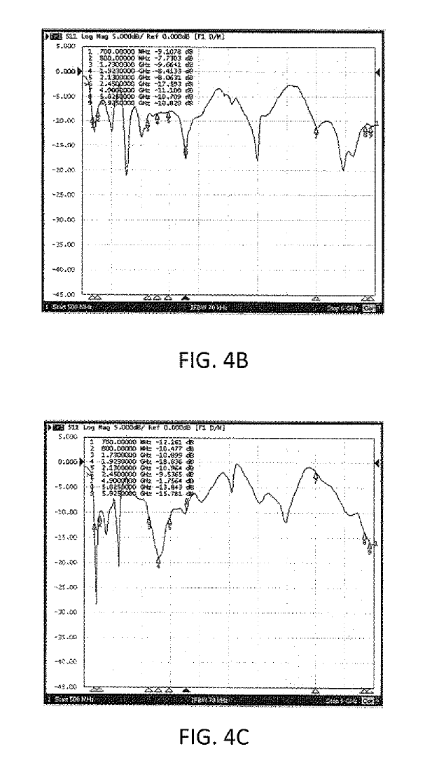

FIG. 4A shows a picture of an alternative design sample of a Broadband Notch Radiator using different matching circuits incorporated on a separate housing (e.g. case) that fits a portable wireless device (e.g. smartphone). In this example, the matching circuit at one of the two ports uses a rectangular patch configuration as Inductance (L), while the other port also uses a rectangular patch configuration, but of a different size, as Inductance (L); hence this is unlike the previous antenna sample which used at one of its two ports a meander line configuration as Inductance (L). Therefore, it should be pointed out here that the shape of Inductance (L) can be of a different geometry and configurations. Thus, the matching circuit is not limited nor confined to the shapes of a rectangular patch, meander line, triangle patch or any other specific geometry.

FIG. 4B shows the measured return loss for frequencies from 500 MHz to 6 GHz for the first port of an alternative design sample of a Broadband Notch Radiator using different matching circuits incorporated on a separate housing (e.g. case) that fits a portable wireless device (e.g. smartphone). The data demonstrates that the measured performance is very good at the targeted frequencies of our interest.

FIG. 4C shows the measured return loss for frequencies from 500 MHz to 6 GHz for the other port of an alternative design sample of a Broadband Notch Radiator using different matching circuits incorporated on a separate housing (e.g. case) that fits a portable wireless device (e.g. smartphone). Again, the measured performance at the desired frequencies of interest is very good.

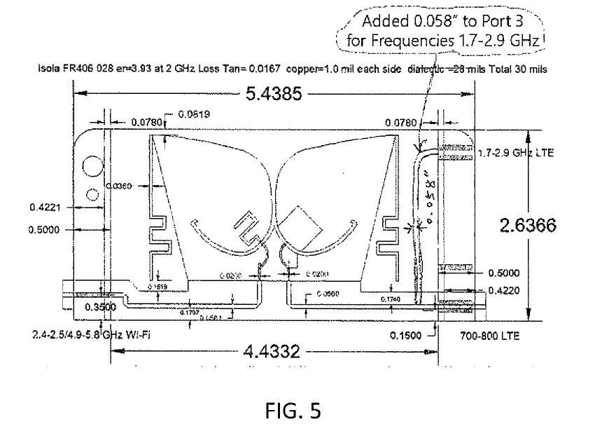

FIG. 5 shows a projected dimensional drawing of a 3-port Broadband Notch Radiator incorporated on a separate housing (e.g. case) that fits a portable wireless device (e.g. smartphone). In this example, a third port with a 0.058″ transmission line was added to a two-port design for covering the frequencies of 1,700-2,900 MHz. The concept is to divide the signal from the second port and the third port. Further tuning of the transmission line impedance may be performed.

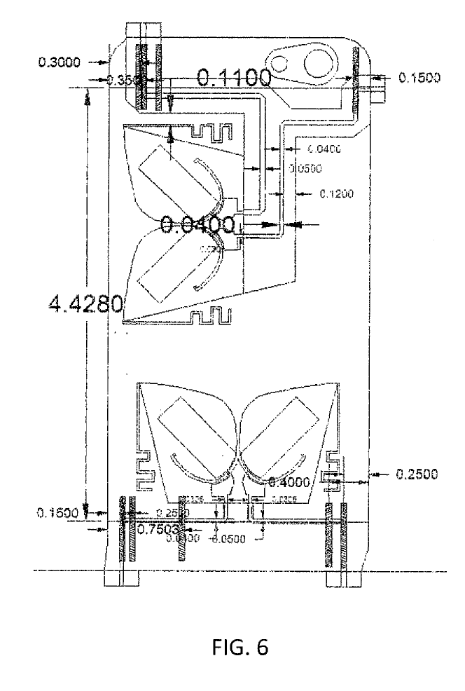

FIG. 6 shows an illustration of two working Broadband Notch Radiators integrated into a separate housing that fits a portable wireless device, in this case a smartphone, in which one element addresses diversity cellular radios and the other element addresses both GPS and WiFi/Bluetooth radios. It should be pointed out here that the matching circuits, rectangular patches, at the two ports are identical. In this use case, there are two similar Broadband Notch Radiator elements, one placed at the top of the housing and the other placed at the bottom of the housing. It also should be pointed out that the matching circuits at these two ports do not have to be identical rectangular patches. The geometry of the matching circuits can be comprised of other shapes and configurations such as unequal size patches, meander lines or any other type per the antenna designer's choice. Regarding inductive coupling, there are two microstrip feed lines, or probes, that couple to the “hot” e-field RF spot which may or may not be the location of the device's embedded antennas. The location(s) of the “hot” e-field RF spot has to be determined before the microstip feed lines, or probes, can be designed and configured.

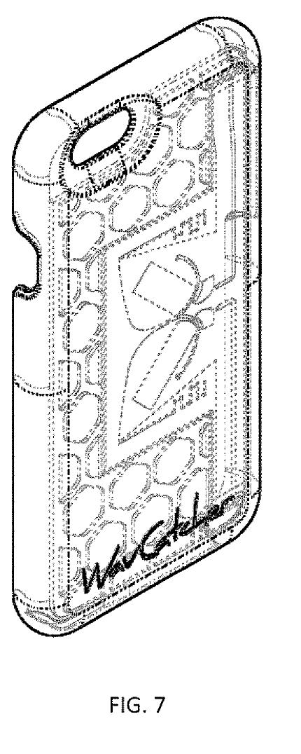

FIG. 7 shows an illustration of the potential housing (e.g. case) to fit a portable wireless device, in this case a smartphone, with a single integrated Broadband Notch Radiator that covers the radios for Cellular, WiFi and Bluetooth. In this use case, a single Broadband Notch Radiator element offers two ports in which one port covers the lower and upper cellular frequencies such as 700-900 MHz/1.7-2.3 GHz and the other port covers the frequencies of interest to meet the WiFi standards for 2.4/5.0/5.8 GHz. The purpose of the housing with the integrated and attenuated Broadband Notch Radiator is to expand the RF coverage of the portable wireless device. The antennas embedded inside the portable device necessitate a smaller form factor as they are confined and restricted to the electronics within as well as the material structure of the device housing. Since the Broadband Notch Radiator is coupled successfully outside of the body of the portable wireless device, its larger aperture size and outward position significantly expands the portable wireless device's RF signaling abilities where targeted.

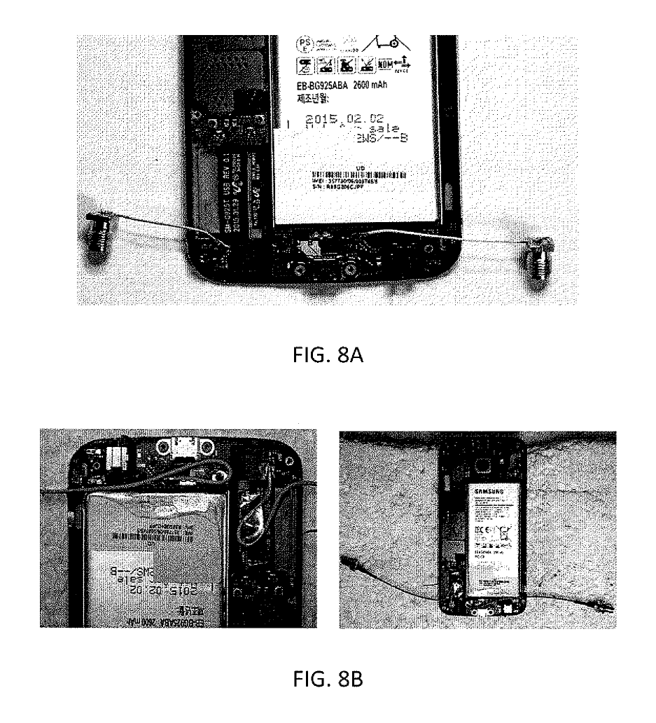

FIG. 8A shows a photo of an inductive coupling use case in which a disassembled smartphone's internal embedded antenna feeds are located. The intent is to identify the optimal location to position the probes of the Broadband Notch Radiator for successful inductive coupling.

FIG. 8B shows photos of an inductive coupling use case in which a pig tail small RF feed probe is used to find where each embedded antenna and frequency band is located with the cable to be connected to a network analyzer. After the soldered RE cable pig tails are secured, the pig tails are connected to the network analyzer port 1. A signal is transmitted from the embedded antenna(s) for a frequency sweep to determine its Return Loss response and to record the applicable frequency cellular/LTE bands.

For the E-Fields the energy is couple as follows. The E-field energy is transmitted to the “Feed Gap,” which is where “Embedded Smart Phone element” is connected to the RF cable Pig tails or other micro RF connector to ground. Typical smart phone manufacture uses a micro RE 50 ohm cable to connect to or feed the embedded element. The Smart phone RF cable center pin is soldered to the embedded tuned element and the RE ground shield soldered to the ground of the smart phone, this is small gap usually 0.02-0.05″ this location is where the Maximum fields are generated on the embedded smart phones.

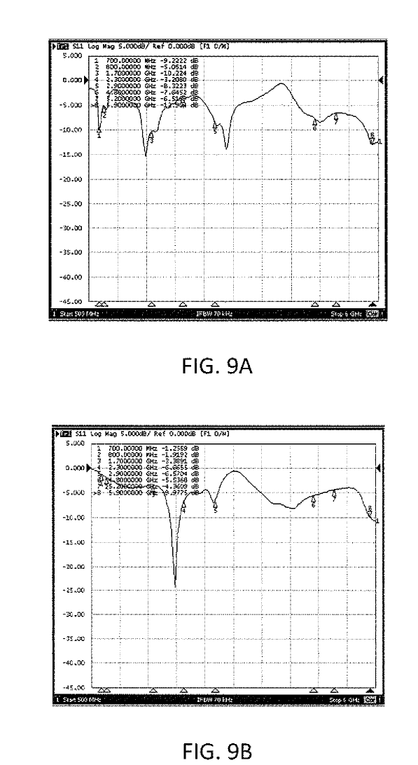

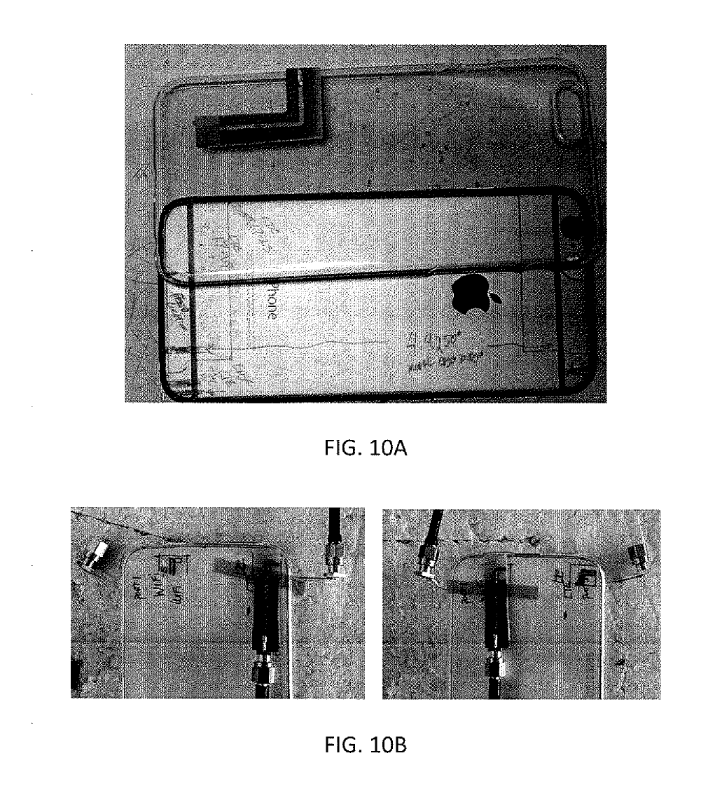

FIG. 9A shows the Return Loss measured data for the port of an embedded cellular antenna referenced in the inductive coupling use case depicted in FIG. 10. The marked points at 1, 2, 3 and 4 confirm that the embedded antenna solution addresses the cellular/LTE radios at the 700-800 MHz and 1.7-2.3 GHz bands.

FIG. 9B shows the Return Loss measured data for the port of a different embedded cellular antenna referenced in the inductive coupling use case depicted in FIG. 8. The marked points at 3 and 4 confirm that the embedded antenna solution addresses the cellular/LTE radios at the 1.7-2.3 GHz bands.

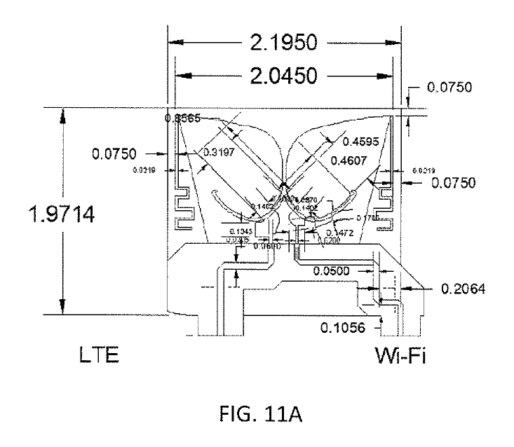

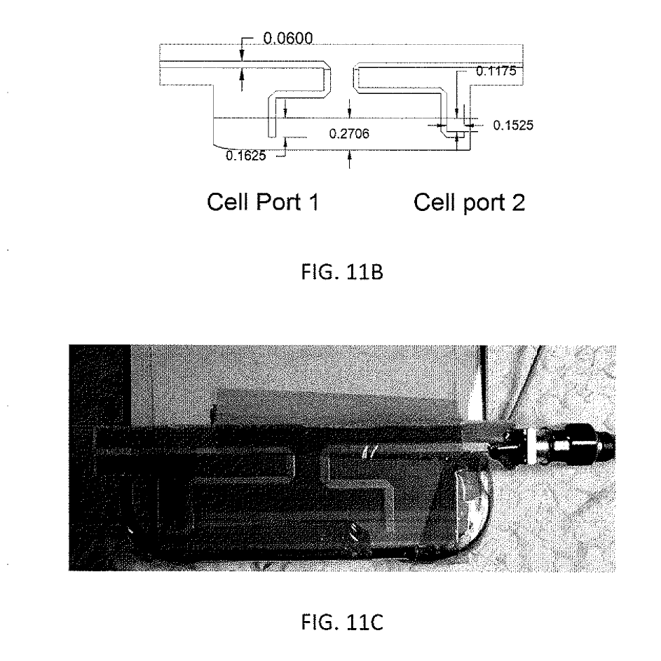

FIG. 10A shows a photo of the dielectric separator utilized in the inductive coupling use case referenced in FIGS. 10 and 11. For this development program, a transparent plastic smartphone case shell is the selected platform for inductive coupling of the Broadband Notch Radiator(s). The transparent case has a thickness of approximately 40 mils. A microstrip with a small amount of ground removed at 0.1″ to 0.3″ straight or right angle is applied to the transparent case over the “hottest” e-field region. The “Maximum Coupled Hot Probe” areas are where the specific Smart phone embedded antennas E-fields are located, whether is it 0.1″ straight to 0.3″ right angle. This Probe geometry may be similar on most smart phones. When the “Right angle” to the overhanging probe is added, the probe also picked up the low frequencies and High frequencies at −10 to −20 Db coupling.

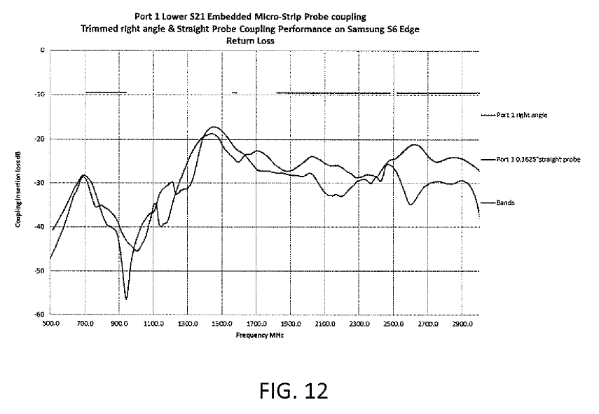

FIG. 10B shows photos of the process of locating the RF “hot” E-fields on each side of the transparent plastic smartphone case shell referenced in FIG. 12A.

FIG. 11A shows a technical drawing of a Broadband Notch Radiator with a Straight Microstrip Probe and a Straight Microstrip Probe With Right Angle located at the end of the feedlines utilized in the inductive coupling use case referenced in FIGS. 10, 11 and 12.

FIG. 11B shows a technical drawing of a Straight Microstrip Probe and a Straight Microstrip Probe With Right Angle test fixture utilized in the inductive coupling use case referenced in FIGS. 8, 9 and 10.

FIG. 11C shows a photo of a Straight Microstrip Probe and a Straight Microstrip Probe With Right Angle test fixture utilized in the inductive coupling use case referenced in FIGS. 8, 9, 10 and 11B.

FIG. 12 shows the measured data resulting from use of the probe text fixture referenced in FIGS. 11B and 11C regarding the inductive coupling use case referenced in FIGS. 8, 9, 10 and 11.

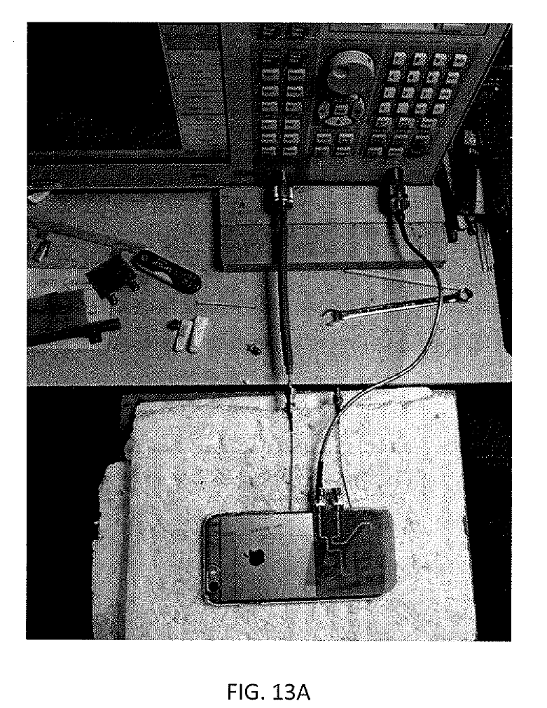

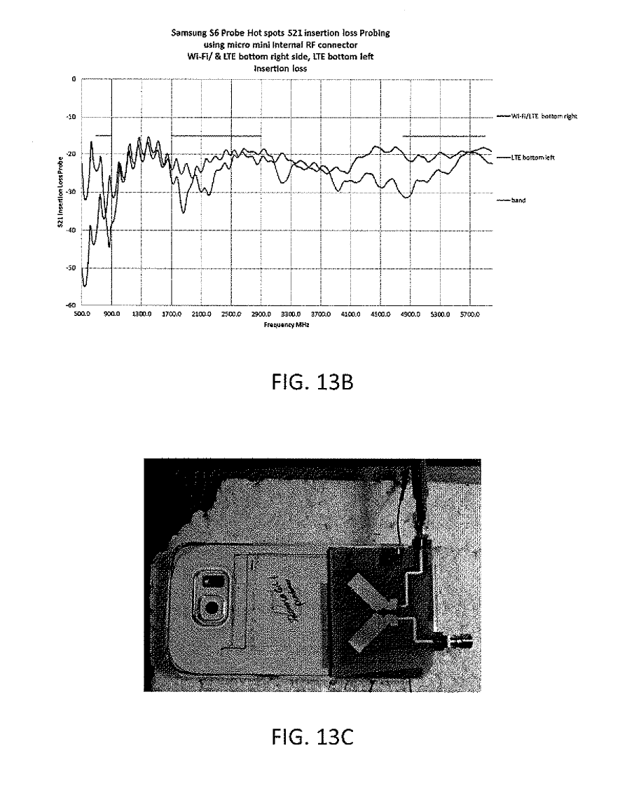

FIG. 13A shows a photo of a network analyzer connected to the wireless portable device covered by the Broadband Notch Radiator integrated platform referenced in the inductive coupling use case referenced in FIGS. 8-12. The purpose is to demonstrate the action of probing for the “hottest” RF e-field spots using a network analyzer s21 transmit and receive: transmit with embedded smart phone antenna pig tail feed and receive with microstrip probe; moving the probe around to locate the best s21 response

FIG. 13B shows the Rectangular s21 plots depicting the embedded and microstrip “hot” e-field responses of the tested device indicated in FIG. 13A concerning the inductive coupling use case referenced in FIGS. 8-12.

FIG. 13C shows a photo of the tested device locking down the location of the Broadband Notch Radiator on the dielectric separator (transparent case) finalizing the inductive coupling procedures in the use case detailed in FIGS. 8-13. After the best “hot” RF e-fields are located, the location of the Broadband Notch Radiator on the dielectric platform is locked down. Microstrip lines are then connected to the Broadband Notch Radiator for performance optimization.

Note that the matching circuits can be modified accordingly for the desired applications. The shape of L (Inductance) can be meander line, rectangular patch or any other shapes suited for the application. The shape of C (Capacitance) can be the throat at the region behind the feed line and other type of shapes suited for the application. Regarding the size of the matching circuits, it is the choice of the designers to optimize the performance to meet the requirements or specifications for the application.

Implementations described above are not intended to be limited to the descriptions above. For example, the lengths of the meander line inductors and surface area and shape of the inductive patch may be varied to achieve a desired inductance. Matching circuits are also limited to inductor and capacitor pairings. For example, a matching circuit may be formed the spiral inductor 1020 and the rectangular capacitor 1008.

It is appreciated that the previous description of the disclosed embodiments is provided to enable a person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system comprising:
a dielectric substrate having a first surface and a second surface;
a conductive material disposed on the first surface to form a horn-shaped dielectric notch and a meander line connected to one or both edges of the horn-shaped notch; and
one or more microstrip feed lines and one or more inductance matching circuits disposed on the second surface, the one or more inductance matching circuits connecting to the one or more feed lines.
